(19) United States
(12) Patent Application Publication
(10) Pub. No.: US 2004/0116089 A1
(43) Pub. Date: Jun. 17, 2004

(54) High frequency composite component

(76) Inventors: Chang Yong Lee, Sungnam (KR); Hyoung Ho Kim, Suwon (KR); Yu Seon Shin, Seoul (KR)

Correspondence Address: LOWE HAUPTMAN GOPSTEIN, GILMAN & BERNER, LLP, Suite 310, 1700 Diagonal Road, Alexandria, VA, 22314, US

(21) Appl. No.: 10/420,752

(22) Filed: Apr. 23, 2003

(30) Foreign Application Priority Data
Dec. 16, 2002 (KR) 2002-80127

(51) Int. Cl. H04B 1/00

(52) U.S. Cl. 455/140; 455/143

(57) ABSTRACT

The present invention relates to a high frequency composite component used in a front end section for processing a high frequency signal between a transceiving section and an antenna in a high frequency circuit of a mobile communication device. The high frequency composite component communicates signals with a communication system and a GPS via an antenna, and comprises: a diplexer for dividing signals received via the antenna into first and second frequency bands, providing first and second frequency band signals to the communication system and the GPS receiver, respectively, and transmitting a signal from the communication system to the antenna; a Surface Acoustic Wave (SAW) duplexer connected to both of the diplexer and the communication system for separating a transmission signal and received signal from the first frequency band; dividing a transmission signal in the first frequency band from a received signal in the first frequency band; and an SAW GPS filter connected to both of the diplexer and the GPS receiver for filtering a GPS signal from the second frequency band signal and transmitting the GPS signal to the GPS receiver. The composite component improves qualities of the mobile communication device as well as reduces its size.

### BACKGROUND OF THE INVENTION

1. Field of the Invention

The present invention relates to a high frequency composite component. In particular, the high frequency composite component of the invention is used in a front end section for processing a high frequency signal between a transceiving section and an antenna in a high frequency circuit of a mobile communication device, and incorporates a diplexer, an SAW duplexer and a GPS filter used in the front end section into one module via a multilayer ceramic substrate, thereby improving qualities of the mobile communication device as well as reducing the size thereof.

2. Description of the Related Art

According to the current trend of size reduction and functional diversification, a mobile communication terminal currently in use tends to incorporate a Global Positioning System (GPS) or a GPS receiver therein, thereby constituting a composite article. As a result, the GPS receiver is getting essentially mounted on the mobile communication terminal. Although several components are currently assembled to realize the GPS receiver in the mobile communication terminal, the art more highly requires a novel communication component which incorporates the several components into one module in order to reduce the size of the mobile communication terminal as well as to enhance the performance thereof.

In order to incorporate the GPS receiver into the mobile communication terminal to constitute a new article, several components such as a diplexer, a Surface Acoustic Wave (SAW) duplexer and a GPS SAW filter are typically required. Arrangement relation of these components is schematically shown in FIG. 1.

FIG. 1 is a block diagram illustrating a front end section of a conventional mobile communication terminal having a GPS receiver combined thereto. Referring to FIG. 1, a diplexer 11 divides signals received via an antenna 10 into a high frequency band and a low frequency band so that the signals can be used in a dual band mode. The signals typically received via the antenna are distributed to a CDMA system or a PCS system. The diplexer also functions to transmit signals from the CDMA or PCS system to the antenna. Further, the dual band mode can be used between the CDMA system and a GPS receiver of the invention.

An SAW duplexer 12 separates the received signals from the antenna and the transmission signals from a communication system such as the CDMA system. That is, the SAW duplexer 12 sends the received signals from the diplexer 11 to a receiving block RX of the communication system such as the CDMA system and the transmission signals from a transmitting block TX of the communication system to the diplexer 11.

Conventionally, a dielectric duplexer has been used as a duplexer. However, other lighter and smaller duplexers are currently substituting the dielectric duplexers, since the dielectric duplexers are bulky and heavy. Therefore, the SAW duplexer is generally used as a duplexer which is typically used in a CDMA frequency band.

A GPS filter 13 selectively filters GPS signals from various signals. Since the GPS signals typically exist in the form of received signals, the GPS filter 13 need not divide transmitting and receiving signals and thus comprises only a receiving block.

Those components such as the diplexer, the duplexer and the GPS filter as above are mounted on a communication terminal separately. Therefore, a first matching circuit 15 between the diplexer 11 and the duplexer 12 and a second matching circuit 16 between the diplexer 11 and the GPS filter 13 are needed to match characteristics of the mobile communication terminal. The matching circuits 15 and 16 may be various according to the type of terminal, and match the characteristics of the terminal by generally using inductors or capacitors.

A conventional technology for constituting the above several components into one composite module is disclosed in Korean Patent Application Serial No. 2002-29238. FIG. 2 shows a block diagram of Korean Patent Application Serial No. 2002-29238, and FIG. 3 shows a construction of dielectric layers constituting a laminated structure of a high frequency composite component.

The above application is proposed to prevent the above problems such as the increasing number of components and the increasing insertion loss caused by the matching circuit when the diplexer and the duplexer are separately constructed and mounted on a single mobile communication terminal. This application provides a high frequency composite component incorporating an SAW duplexer 22 and a diplexer 21. Also, FIG. 3 specifically shows dielectric layers of a laminated structure for realizing the above high frequency composite component.

In FIG. 2, a first port P11 of the diplexer 21 is connected to an antenna ANT, a second port P12 of the diplexer 21 is connected to a first port P21 of the duplexer 22, a third port P13 of the diplexer 21 is connected to one end HF of a second communication system which processes high frequency band signals. A second port P22 of the duplexer 22 is connected to a receiving block RX of a first communication system, and a third port P23 of the duplexer 22 is connected to a transmitting block TX of the first communication system. The second communication system can be a GPS receiver.

In order to realize a GPS function in the composite component which incorporates the diplexer and the duplexer functioning as above into one package, a GPS filter is separately mounted on a substrate of the mobile communication terminal. As a result, the distance for transmitting a signal received via the antenna to the GPS filter is increased, causing a certain level of signal loss. In order to solve this problem, a strip line 20 was formed in a seventh dielectric layer S7 in FIG. 3. Also, the composite module requires realizing the diplexer in multilayered substrates such as the Low Temperature Co-fired Ceramic (LTCC). Since the interval between upper and lower grounding plates S2 and S9 is shortened compared to the height of each of the several conventional components, the composite module requires a technology for designing a pattern which can prevent interference between each of the grounding plates and its upper and lower patterns. In order to solve the above problem of interference, open areas 21, 22 and 23 without conductive patterns are formed in the grounding plates S2 and S9 as shown in FIG. 3.

The seventh dielectric layer S7 in FIG. 3 has a pattern at one side which forms a capacitor C3 connected to the antenna and another pattern at the other side which forms a capacitor C5 connected to the GPS receiver. FIG. 3 shows a conventional example in which the antenna and a GPS port are placed opposite to each other in lateral faces of the substrate, by which the capacitors C3 and C5 are necessarily spaced from each other on the seventh dielectric layer S7. If the two capacitors C3 and C5 are simply connected with a conductive pattern, interference increases between the conductive pattern and the grounding layer of the ninth dielectric layer S9. In order to solve this problem, an open area can be formed on the grounding layer of the ninth dielectric layer S9. However, this may excessively enlarge the open area of the grounding layer and thus deteriorate grounding characteristics. As another solution, a strip line set to an impedance of about 50 ohm is connected between the two terminals to minimize the interference with the grounding layer and the following signal loss. However, such a strip line further requires matching circuits such as L3 and L4, thereby making a circuit of the composite component complex. Moreover, L3 causes to form the open area 22 in the second dielectric layer S2, thereby to deteriorate the grounding characteristics.

That is to say, if the GPS receiver is connected to the conventional duplexer-diplexer composite component, there are several design restrictions such as the strip line formed to avoid the signal loss and the open areas formed to prevent the interference with the ground patterns. Such restrictions in design result in various characteristic-deteriorating factors, in that the number of devices provided on the substrate is increased and the patterns are prolonged. As the GPS filter is mounted on the mobile communication terminal as a separate component, the number of components in the front end section is increased and thus it becomes difficult to reduce the size of the mobile communication terminal.

Therefore, the art has pursued for a novel structure which can incorporate the conventional composite module including the duplexer and the diplexer into a single module together with the GPS filter, and by which all of the above-mentioned functions can be realized in the single composite module and the signal loss can be removed.

### SUMMARY OF THE INVENTION

The present invention has been made to solve the above problems of the prior art and it is therefore an object of the present invention to incorporate a diplexer, a duplexer and a GPS filter used in a front end section of a mobile communication terminal into a single module in order to reduce the size and the component number of the mobile communication terminal.

It is another object of the invention to provide a single module including a GPS filter to reduce signal loss owing to a conventional connection structure, in which a diplexer-duplexer composite component is separate from the GPS filter, as well as further simplify the configuration of ground plates and other dielectric layers so that patterns are readily designed.

According to an aspect of the invention for realizing the above objects, a high frequency composite component for communicating signals with a communication system and a GPS via an antenna comprises: a diplexer for dividing signals received via the antenna into first and second frequency bands, providing first and second frequency band signals to the communication system and the GPS receiver, respectively, and transmitting a signal from the communication system to the antenna; a Surface Acoustic Wave (SAW) duplexer connected to both of the diplexer and the communication system for separating a transmission signal and received signal from the first frequency band; dividing a transmission signal in the first frequency band from a received signal in the first frequency band; and an SAW GPS filter connected to both of the diplexer and the GPS receiver for filtering a GPS signal from the second frequency band signal and transmitting the GPS signal to the GPS receiver.

It preferred that the high frequency composite component of the invention may further comprise a laminated structure formed via lamination of a plurality of dielectric layers, wherein the diplexer comprises a conductive pattern on at least some of the dielectric layers, and wherein the laminated structure has a cavity in an upper central portion thereof, the cavity being capable of mounting the duplexer and the GPS filter.

It is preferred that the communication system may comprise a CDMA system which operates in a frequency range of about 824 to 894 MHz.

According to another aspect of the invention for realizing the above objects, a high frequency composite component for communicating signals with a communication system and a GPS via an antenna comprises: a dielectric laminated structure including a low-pass filter layer, a pair of grounding layers having open areas in portions thereof and a high-pass filter layer disposed between the pair of grounding layers and having a number of capacitance elements realized via conductive patterns in positions corresponding to the open areas for forming a diplexer, the dielectric laminated structure having a cavity in an upper central portion thereof; an SAW duplexer and an SAW GPS filter installed in the cavity; and a protective layer overlying the laminated structure for sealing the cavity.

It is preferred that the low-pass filter layer can pass a signal in a frequency band of about 824 to 894 MHz which is processed by a CDMA system, and the high-pass filter layer can pass a signal in a high frequency band which is processed by the GPS receiver.

It is also preferred that the dielectric laminated structure may have four lateral faces having signal ports which are respectively connected to the antenna, a receiving block of the communication system, a transmitting block of the communication system and the GPS receiver, wherein the signal ports connected to the antenna and the GPS receiver may be arranged opposite to each other.

It is preferred that the SAW duplexer and the SAW GPS filter may be installed in the cavity of the dielectric laminated structure via wire bonding or flip chip bonding.

It is also preferred that the SAW duplexer may include a transmitting SAW filter, a receiving SAW filter and a phase transformation device connected between the transmitting SAW filter and the receiving SAW filter, wherein the phase transformation device may be a λ/4 strip line which is formed via the conductive patterns on any of the dielectric layers of the dielectric laminated structure.

According to yet another aspect of the invention for realizing the above objects, a high frequency composite component for communicating signals with a communication system and a GPS via an antenna comprises: a dielectric laminated structure including a low-pass filter layer, a pair of grounding layers and a high-pass filter layer for constituting a diplexer, the dielectric laminated structure having a cavity in an upper central portion thereof; an SAW duplexer and an SAW GPS filter installed in the cavity; and a protective layer overlying the laminated structure for sealing the cavity, wherein the pair of grounding layers have open areas in portions thereof, wherein the high-pass filter layer of the dielectric laminated structure is formed of a plurality of dielectric layers laminated between the pair of grounding layers, and includes at least three capacitance elements and at least one inductance element which are formed via conductive patterns in positions corresponding to the open areas, and wherein the low-pass filter layer of the dielectric laminated structure is formed over the high-pass filter layer, separated from the high-pass filter via the grounding layers.

It is preferred that the low-pass filter layer may pass a signal in a frequency band of about 824 to 894 MHz which is processed by a CDMA system, and the high-pass filter layer may pass a signal in a high frequency band which is processed by the GPS receiver.

It is preferred that the dielectric laminated structure may have four lateral faces having signal ports which are respectively connected to an antenna, a receiving block of the communication system, a transmitting block of the communication system and the GPS receiver, wherein the signal ports connected to the antenna and the GPS receiver may be arranged opposite to each other.

It is preferred that the SAW duplexer and the SAW GPS filter may be installed in the cavity of the dielectric laminated structure via wire bonding or flip chip bonding.

It is also preferred that the SAW duplexer may include a transmitting SAW filter, a receiving SAW filter and a phase transformation device connected between the transmitting SAW filter and the receiving SAW filter, wherein the phase transformation device may be a λ/4 strip line which is formed via the conductive patterns on any of the dielectric layers of the dielectric laminated structure.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram illustrating a front end section of a conventional mobile communication terminal having a GPS receiver combined thereto;

FIG. 2 is a block diagram schematically illustrating a construction of a conventional high frequency composite component;

FIG. 3 is an exploded perspective view illustrating a construction of dielectric layers constituting laminated structure of a conventional high frequency composite component;

FIG. 4 is a block diagram illustrating a circuit construction of a high frequency composite component of the invention;

FIG. 5A is a plan view of a high frequency composite component of the invention;

FIG. 5B is a side sectional view of FIG. 5A;

FIG. 6 is a construction of dielectric layers constituting a laminated structure of a high frequency composite component of the invention;

FIG. 7 is a graph illustrating characteristic values of a duplexer used in the high frequency composite component of the invention; and

FIG. 8 is a graph illustrating characteristic values of a GPS filter used in the high frequency composite component of the invention.

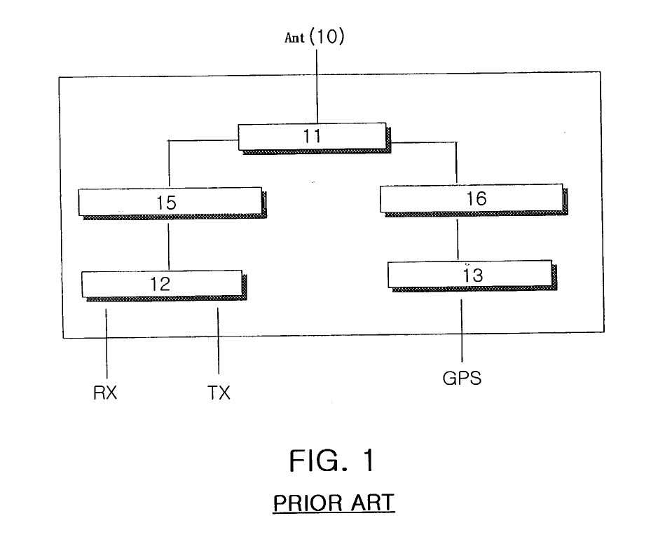

### DETAILED DESCRIPTION OF THE PREFERRED EMBODIMENT

The following detailed description will present a preferred embodiment of the invention in reference to the accompanying drawings, in which well-known functions or constructions will not be described in detail since they may unnecessarily obscure the understanding of the invention.

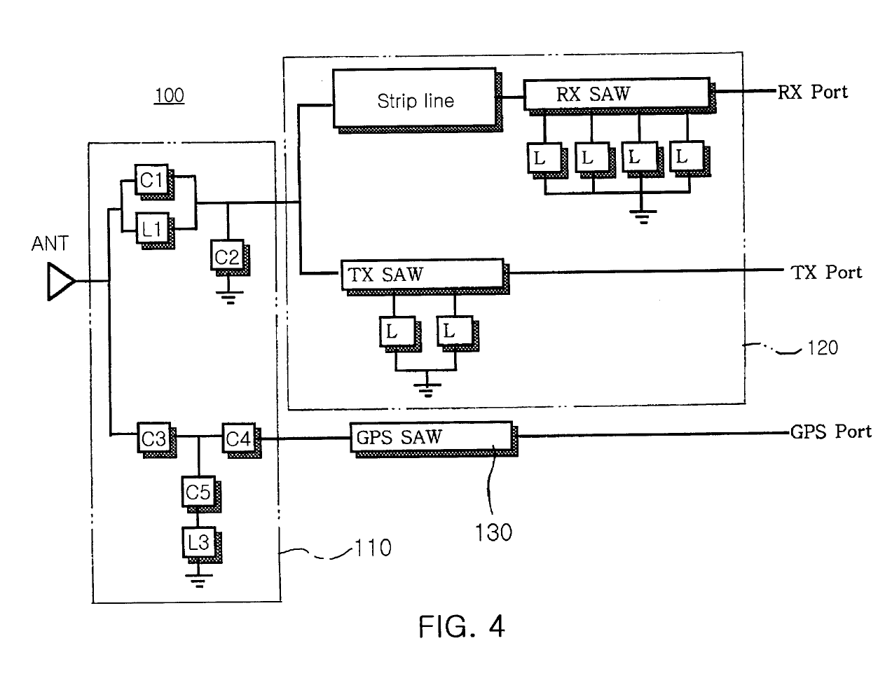

FIG. 4 is a block diagram illustrating a circuit construction of a high frequency composite component of the invention. A high frequency composite component 100 of the invention includes a diplexer 110, a Surface Acoustic Wave (SAW) duplexer 120 and a GPS filter 130.

The diplexer 110 divides signals received via an antenna ANT into a first frequency band signal and a second frequency band signal. The diplexer 110 is connected to the antenna ANT and typically used to distribute signals to a communication system which has two different types of frequency bands. In the invention, the diplexer 110 distributes the signals to corresponding systems, i.e., a communication system and a GPS receiver. The diplexer 110 also functions to send a signal from the communication system to the antenna. Since the GPS receiver typically uses only a received signal, it is unnecessary to separate transmitting and receiving functions in respect to the GPS receiver.

The SAW duplexer 120 is connected to both of the diplexer 110 and the communication system, and serves to separate signals corresponding to a first frequency band into a transmission signal and a received signal. The SAW duplexer 120 comprises a receiving block RX for receiving a signal from the diplexer and a transmitting block TX for sending a signal from the communication system to the diplexer 110. The SAW duplexer typically includes two SAW filters and a phase transformation device. Since the SAW filters are inadequate for processing a high frequency of about 1 GHz or more, a first communication system adopting the SAW filters is preferably a CDMA system which processes a signal in the frequency range of 824 to 894 MHz.

The GPS filter 130 is connected to both of a high frequency end of the diplexer 110 and the GPS receiver. The GPS receiver receives a number of information such as geographic information on a high frequency signal via an antenna. The GPS filter separates a GPS signal from the high frequency signal, i.e., the second frequency band signal, and transmits the separated GPS signal to the GPS receiver. The GPS filter also utilizes an SAW filter.

In the prior art, those components are individually assembled to the circuit, or only the diplexer and the duplexer are incorporated into one component. However, if only the diplexer and the duplexer are incorporated into one composite component, the GPS filter is mounted separate from the diplexer-duplexer composite component on the mobile communication terminal, thereby prolonging a signal transmission path up to the GPS filter and thus creating a certain level of signal loss. The present invention provides the composite component to incorporate the GPS filter, and as an effect, greatly reduces the above-mentioned signal loss, in particular, insertion loss. Further, the composite component of the invention can greatly contribute to miniaturization of a mobile communication terminal.

According to a preferred embodiment of the invention, the communication system is in the form of a CDMA system using a frequency in the range of about 824 to 894 MHz. The GPS receiver typically uses a high frequency of about 1570 to 1580 MHz.

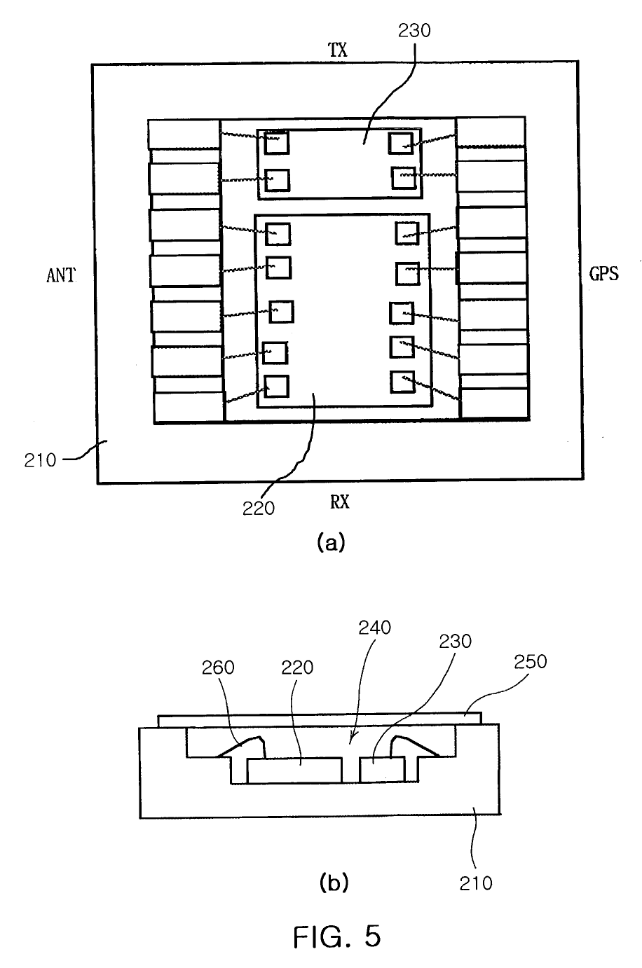

A laminated structure 210 as shown in FIGS. 5A and 5B is formed through lamination of a plurality of dielectric layers, and the diplexer is preferably realized via conductive patterns on at least a portion of the dielectric layers. The diplexer 110 is realized by forming a pattern on a dielectric multilayer substrate via LTCC technique using LC resonance characteristics. Also, the laminated structure 210 has a cavity 240 in an upper central portion thereof, in which chips of the duplexer 120 and the GPS filter 130 can be installed. Detailed description of the chips will be made later.

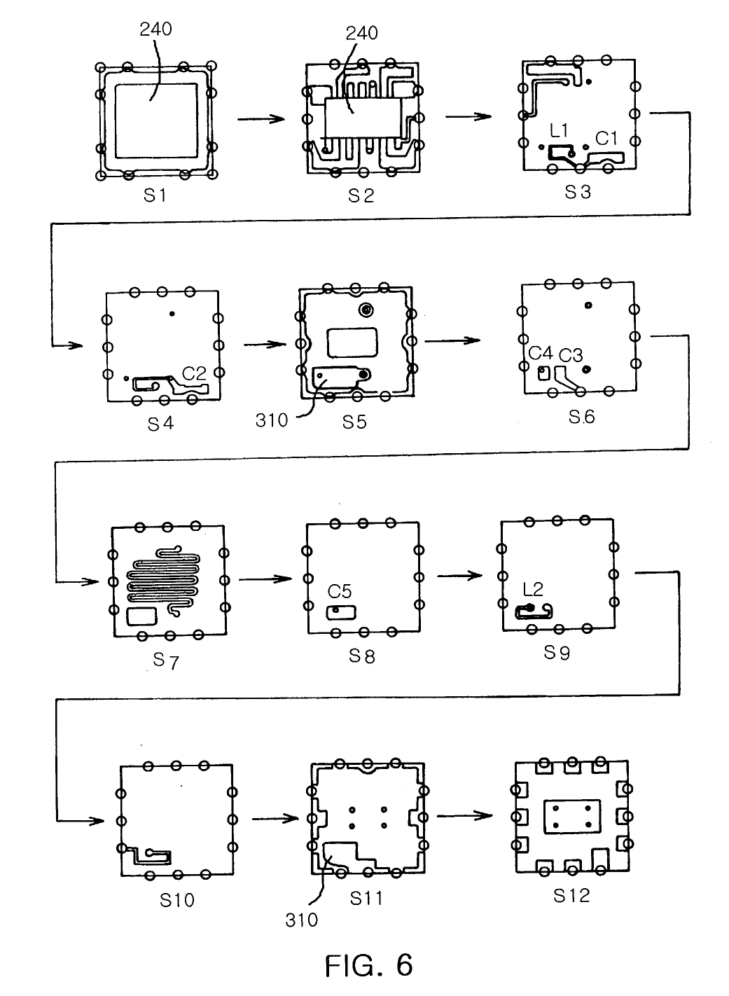

The high frequency composite component of the invention is realized via the dielectric laminated structure. FIG. 5A is a plan view of the high frequency composite component of the invention, FIG. 5B is a side sectional view of FIG. 5A, and FIG. 6 is a construction of dielectric layers constituting a laminated structure of the high frequency composite component of the invention.

The dielectric laminated structure 210 is formed through lamination of the dielectric layers, and has the cavity 240 in the upper central portion thereof for mounting an SAW duplexer 220 and an SAW GPS filter 230. In the dielectric laminated structure 210, a diplexer includes a low-pass filter layer, grounding layers and a high-pass filter layer.

The low-pass filter layer is constituted of a resonance circuit portion including capacitors C1 and C2 and an inductor L1 shown in an upper portion of the diplexer 110 in FIG. 4, and passes a signal in the frequency range of about 824 to 894 MHz which is processed by the CDMA system. The low-pass filter layer is realized via a pattern portion formed on third and fourth dielectric layers S3 and S4 of the dielectric layers shown in FIG. 6.

The high-pass filter layer is formed through lamination of a number of dielectric layers, and comprises capacitors C3 to C5 and an inductor L3 shown in FIG. 4 under the diplexer 110. The high-pass filter layer typically includes three capacitance elements. In a construction of the composite component of the invention including the GPS filter, the three capacitance elements are collected adjacent to one another. The capacitance elements are formed via conductive patterns on the dielectric layers, and pass a signal in a high frequency band which is processed by the GPS receiver. The high-pass filter is shown in sixth to tenth dielectric layers S6 to S10 of FIG. 6.

The grounding layers are arranged in upper and lower portions of the high-pass filter layer, and characterized in that open areas 310 are formed in some portions thereof. The grounding layers are formed on the fifth and eleventh dielectric layers S5 and S11 having the open areas 310, which are respectively formed in corresponding positions. The open areas 310 prevent interference between the grounding layers and the patterns on the upper and lower dielectric layers such as the capacitances on the high-pass filter layer, so that capacitance and/or inductance realizing elements can be formed in some areas of the dielectric layers between the grounding layers corresponding to the open areas. Also, the filter layer S5 is placed between the high-pass filter layer and the low-pass filter layer and functions to separate the two layers.

Now FIG. 6 will be described in more detail. The laminated structure comprises the first to twelve dielectric layers, and the cavity 240 for mounting the SAW duplexer and the GPS filter is formed in central portions of the first and second dielectric layers. A conductive pattern is formed on the second dielectric layer S2 for connection with the chips of the duplexer and the GPS filter.

The first capacitor C1 and the first inductor L1 are formed on the third dielectric layer S3 in order to realize the diplexer. The first inductor L1 is connected to the fourth dielectric layer S4, and the second capacitor C2 is formed on the fourth dielectric layer S4. The fifth dielectric layer S5 of the grounding layers is provided with the open area 310 to prevent interference with the capacitance elements. The third and fourth dielectric layers S3 and S4 comprise the low-pass filter of the diplexer.

The capacitance elements C3 and C4 corresponding to the open areas 310 of the fifth dielectric layer are formed on the sixth dielectric layer S6. The capacitance elements C3 and C4 form a capacitor in cooperation with the seventh dielectric layer S7 which forms the capacitor C5 in cooperation with the eighth dielectric layer S8. The capacitance elements C3, C4 and C5 are selectively formed in positions corresponding to the open areas 310 in the fifth and eleventh dielectric layers S5 and S11 which function as the grounding layers. Second inductance elements L2 are formed on the ninth and tenth dielectric layers, in positions corresponding to the open areas 310 of the grounding layers. Terminals are formed on the twelfth dielectric layer S12, which serve to mount the high frequency composite component on a substrate in an actual mobile communication terminal.

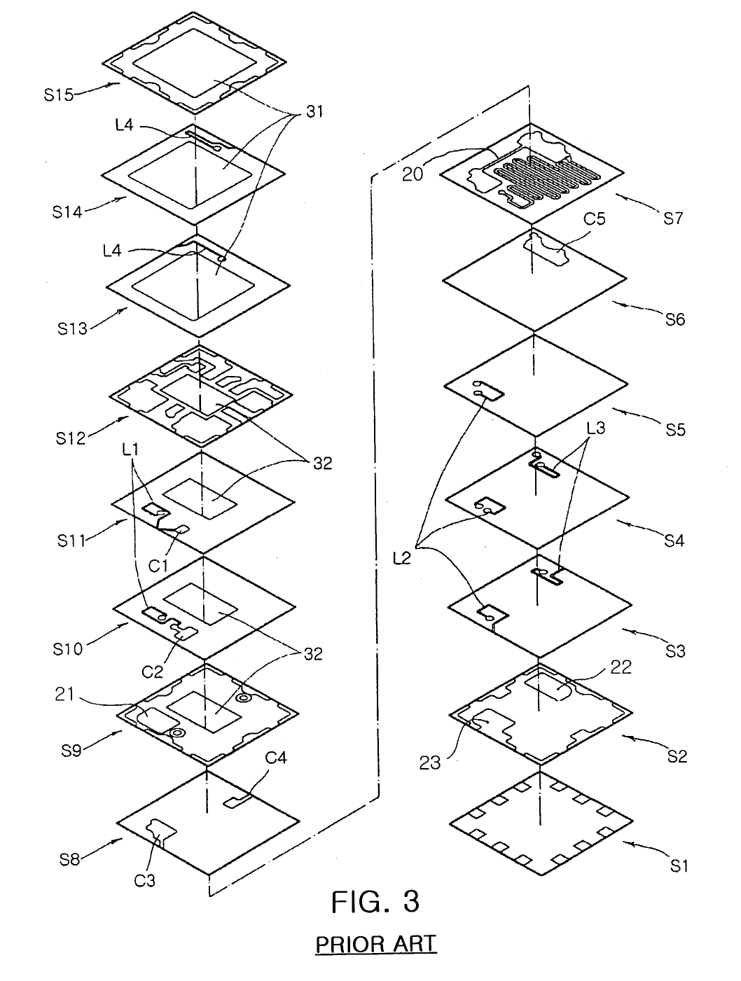

Since the seventh dielectric layer S7 in FIG. 6 of the invention does not require a terminal for forming the capacitor C5 adjacent to the GPS receiver unlike the seventh dielectric layer S7 in FIG. 3 of the prior art, a strip line is not necessary in the above dielectric layer arrangement. This causes formation of the matching inductance elements L3 and L4 to be unnecessary unlike in the prior art decreasing the number of the devices and the pattern layers. Also, this minimizes the open areas in the grounding layers thereby improving the grounding characteristics.

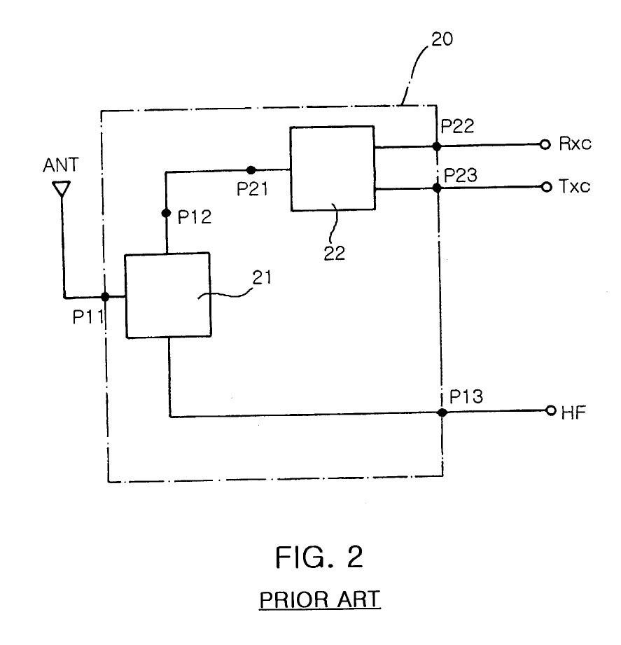

According to the above construction where the interval between the grounding layers is narrowed than that of the conventional single component, the present invention can overcome the above problem that the grounding layers have interference with circuit components arranged between the grounding layers. Although in the prior art the two open areas are formed in the grounding layers as in FIG. 2, the present invention reduces the open areas considerably by incorporating the GPS filter in the single composite component so as to avoid the matching circuit which was needed in the prior art where the GPS filter is installed outside the package. This reduction of open areas prevents the deterioration of the grounding characteristics.

Also, since the path leading to the GPS filter is formed within one composite component, the invention can make the path shorter than that of the conventional construction in FIGS. 2 and 3. This also reduces the insertion loss by large quantities compared to that of the conventional art where the GPS filter is mounted on a PCB of the mobile communication terminal. As a result, qualities of the mobile communication terminal can be improved.

Moreover, if the diplexer, the duplexer and the GPS filter used in the front end section of the mobile communication terminal are incorporated into the single composite module as set forth above, setting signal-processing conditions of one component can directly realize characteristics of other components in an advantageous manner without loss. Since the diplexer, the duplexer and the GPS filter have been conventionally mounted on the mobile communication terminal separately, it has been difficult to arrange these components and realize characteristics thereof. However, the present invention can solve these problems.

In the meantime, the SAW duplexer 220 and the GPS filter 230 shown in FIG. 5B are mounted on the third dielectric layer S3. The SAW duplexer 220 and the GPS filter 230 are connected to the conductive pattern on the second dielectric layer S2. Preferably, the SAW duplexer 220 and the GPS filter 230 are connected via wire bonding using wires 260. Alternatively, flip chip technique can be adopted in which bottoms of the SAW duplexer 220 and the GPS filter 230 are directly connected to the pattern of the dielectric laminated structure without using wires 260.

The duplexer includes a λ/4 strip line functioning as a phase transformation device. The phase transformation device serves to prevent outflow of a transmission signal from the transmitting end to the receiving end. The invention preferably adopts the λ/4 strip line since it is simple in structure and readily realized via the conductive pattern on the dielectric layer even though there are several types of available phase transformation devices.

A protective layer 250 is formed over the cavity 240 of the laminated structure 210 in order to seal and protect the duplexer and the GPS filter installed in the cavity 240. The protective layer 250 is preferably made of metal since it protects the SAW filter, the GPS filter and the wire bonding structure in the cavity 240. Also, the metal protective layer 250 allows the laminated module to be readily handled while stabilizing characteristics of the SAW filter.

As shown in FIG. 5A, the dielectric laminated structure is in the form of a rectangular box having four lateral faces. The lateral faces have signal ports which are respectively connected to the antenna ANT, the receiving block RX of the communication system, the transmitting block TX of the communication system and the GPS filter. In particular, the signal ports of the antenna ANT and the GPS filter are preferably formed opposite to each other according to a design structure required in the mobile communication terminal.

In case that the chips of the duplexer and the GPS filter are connected to the dielectric laminated structure via wire bonding, the internal cavity 240 of the laminated structure 210 can have three steps. The first step of the cavity 240 can mount chips such as the SAW duplexer and SAW GPS filter chips on a central portion thereof. The second step is so projected that an upper face thereof can be connected with the chips via the wires 260. The third step is projected again so that the protective layer 250 can be seated thereon to cover the cavity 240 for sealing and protecting the above-described composite component package.

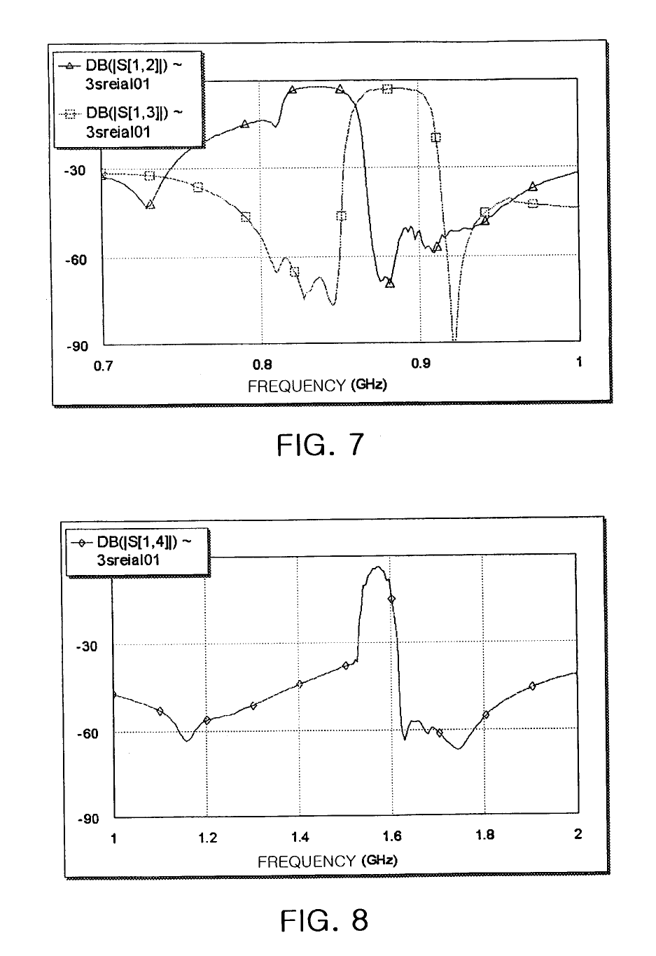

FIG. 7 is a graph illustrating characteristic values of the duplexer used in the high frequency composite component of the invention, and FIG. 8 is a graph illustrating characteristic values of the GPS filter used in the high frequency composite component of the invention.

FIGS. 7 and 8 show simulated analysis characteristics, i.e., insertion loss values according to frequency bands of the composite component of the invention. The graph in FIG. 7 shows that a signal passing through the diplexer in a CDMA band of about 800 MHz is divided into transmission and received signals. FIG. 8 shows that only a GPS signal in a frequency band of about 1.6 GHz passes through the diplexer.

As shown in the above graphs, it is apparent that the diplexer, the duplexer and the GPS filter properly realize their signal characteristics even though they are incorporated into the single composite component of the invention. This means that the composite component of the invention can be adequately adopted in the front end section of the mobile communication terminal.

As set forth above, the invention fabricates the diplexer, the duplexer and the GPS filter used in the mobile communication terminal into the single composite component so as to reduce the mounting space of the composite component compared to that of the individual components which are installed separately, thereby reducing the size and the component number of the mobile communication terminal.

Further, although the prolonging of the signal transmission path to the GPS filter has caused the signal loss in the conventional mobile communication terminal where the GPS filter is separately mounted, this invention can reduce the signal loss by incorporating the GPS filter into the single module. This also further simplifies the configuration of the grounding plates and of other dielectric layers so that the patterns can be readily designed. Since the filter is layered on the multilayer ceramic substrate to realize the filter characteristics in the mobile communication terminal, the size of the mobile communication terminal can be further reduced from the conventional ones. Since the individual devices are realized within the multilayer ceramic substrate, the inter-device path is shortened, the device number is reduced, and the insertion loss is reduced by large amount.

Although the present invention has been described with reference to the preferred embodiment, it is apparent to those skilled in the art that obvious modifications and alterations of the invention may be made without departing from the spirit and scope of the invention which will be defined by the appended claims and equivalents thereof.

What is claimed is:

1. A high frequency composite component for communicating signals with a communication system and a GPS via an antenna, comprising:
a diplexer for dividing signals received via the antenna into first and second frequency bands, providing first and second frequency band signals to the communication system and the GPS receiver, respectively, and transmitting a signal from the communication system to the antenna;
a Surface Acoustic Wave (SAW) duplexer connected to both of the diplexer and the communication system for separating a transmission signal and received signal from the first frequency band;
dividing a transmission signal in the first frequency band from a received signal in the first frequency band; and
an SAW GPS filter connected to both of the diplexer and the GPS receiver for filtering a GPS signal from the second frequency band signal and transmitting the GPS signal to the GPS receiver.

2. The high frequency composite component in accordance with claim 1, further comprising a laminated structure formed via lamination of a plurality of dielectric layers, wherein the diplexer comprises a conductive pattern on at least some of the dielectric layers.

3. The high frequency composite component in accordance with claim 2, wherein the laminated structure has a cavity in an upper central portion thereof, the cavity being capable of mounting the duplexer and the GPS filter.

4. The high frequency composite component in accordance with claim 1, wherein the communication system comprises a CDMA system which operates in a frequency range of about 824 to 894 MHz.

5. A high frequency composite component for communicating signals with a communication system and a GPS via an antenna, comprising:
a dielectric laminated structure including a low-pass filter layer, a pair of grounding layers having open areas in portions thereof and a high-pass filter layer disposed between the pair of grounding layers and having a number of capacitance elements realized via conductive patterns in positions corresponding to the open areas for forming a diplexer, the dielectric-laminated structure having a cavity in an upper central portion thereof;
an SAW duplexer and an SAW GPS filter installed in the cavity; and
a protective layer overlying the laminated structure for sealing the cavity.

6. The high frequency composite component in accordance with claim 5, wherein the low-pass filter layer passes a signal in a frequency band of about 824 to 894 MHz which is processed by a CDMA system.

7. The high frequency composite component in accordance with claim 5, wherein the high-pass filter layer passes a signal in a high frequency band which is processed by the GPS receiver.

8. The high frequency composite component in accordance with claim 5, wherein the dielectric laminated structure has four lateral faces having signal ports which are respectively connected to the antenna, a receiving block of the communication system, a transmitting block of the communication system and the GPS receiver.

9. The high frequency composite component in accordance with claim 8, wherein the signal ports connected to the antenna and the GPS receiver are arranged opposite to each other.

10. The high frequency composite component in accordance with claim 5, wherein the SAW duplexer and the SAW GPS filter are installed in the cavity of the dielectric laminated structure via wire bonding.

11. The high frequency composite component in accordance with claim 5, wherein the SAW duplexer and the SAW GPS filter are installed in the cavity of the dielectric laminated structure via flip chip bonding.

12. The high frequency composite component in accordance with claim 5, wherein the SAW duplexer includes a transmitting SAW filter, a receiving SAW filter and a phase transformation device connected between the transmitting SAW filter and the receiving SAW filter.

13. The high frequency composite component in accordance with claim 12, wherein the phase transformation device is a λ/4 strip line which is formed via the conductive patterns on any of the dielectric layers of the dielectric laminated structure.

14. A high frequency composite component for communicating signals with a communication system and a GPS via an antenna, comprising:
a dielectric laminated structure including a low-pass filter layer, a pair of grounding layers and a high-pass filter layer for forming a diplexer, the dielectric laminated structure having a cavity in an upper central portion thereof;
an SAW duplexer and an SAW GPS filter installed in the cavity; and
a protective layer overlying the laminated structure for sealing the cavity,
wherein the grounding layers have open areas in portions thereof,
wherein the high-pass filter layer of the dielectric laminated structure is formed of a plurality of dielectric layers laminated between the pair of grounding layers, and includes at least three capacitance elements and at least one inductance element which are formed via conductive patterns in positions corresponding to the open areas, and
wherein the low-pass filter layer of the dielectric laminated structure is formed over the high-pass filter layer, separated from the high-pass filter via the grounding layers.

15. The high frequency composite component in accordance with claim 14, wherein the low-pass filter layer passes a signal in a frequency band of about 824 to 894 MHz which is processed by a CDMA system.

16. The high frequency composite component in accordance with claim 14, wherein the high-pass filter layer passes a signal in a high frequency band which is processed by the GPS receiver.

17. The high frequency composite component in accordance with claim 14, wherein the dielectric laminated structure has four lateral faces having signal ports which are respectively connected to an antenna, a receiving block of the communication system, a transmitting block of the communication system and the GPS receiver.

18. The high frequency composite component in accordance with claim 17, wherein the signal ports connected to the antenna and the GPS receiver are arranged opposite to each other.

19. The high frequency composite component in accordance with claim 14, wherein the SAW duplexer and the SAW GPS filter are installed in the cavity of the dielectric laminated structure via wire bonding.

20. The high frequency composite component in accordance with claim 14, wherein the SAW duplexer and the SAW GPS filter are installed in the cavity of the dielectric laminated structure via flip chip bonding.

21. The high frequency composite component in accordance with claim 14, wherein the SAW duplexer includes a transmitting SAW filter, a receiving SAW filter and a phase transformation device connected between the transmitting SAW filter and the receiving SAW filter.

22. The high frequency composite component in accordance with claim 21, wherein the phase transformation device is a λ/4 strip line which is formed via the conductive patterns on any of the dielectric layers of the dielectric laminated structure.
